(19) United States
(12) Patent Application Publication
(10) Pub. No.: US 2024/0354488 A1
(43) Pub. Date: Oct. 24, 2024

(54) SYSTEM AND METHOD FOR PROVIDING A PERSONALIZED WEB BROWSING EXPERIENCE

(71) Applicant: Ethan John Petroka, Saradota, FL (US)

(72) Inventor: Ethan John Petroka, Saradota, FL (US)

(21) Appl. No.: 18/509,501

(22) Filed: Nov. 15, 2023

Related U.S. Application Data
(60) Provisional application No. 63/460,915, filed on Apr. 21, 2023.

(51) Int. Cl. G06F 40/106; G06F 16/957; G06F 16/958

(52) U.S. Cl. CPC G06F 40/106; G06F 16/9577; G06F 16/986

(57) ABSTRACT

A system and method are provided to provide a personalized webpage experience. The system comprises a server with an analytics machine and a tracking machine. When a visitor accesses a webpage on a hosting server that has given the system access, the system tracks the visitor's actions and conversions to learn more about the visitor. The system's analytics machine analyzes the visitor's actions to generate targeted script changes to the original layout of the web page. The targeted scripts change depending on the information gathered from the visitor's web browsing habits. The changes include but are not limited to changes to the HTML of the website and the CSS. The system is configured to determine whether there is enough information on the visitor to make a change to the original layout of the web page and whether the changes can occur within a specified threshold to avoid unwanted latency.

### FIELD OF THE INVENTION

The present invention generally relates to systems and methods for personalizing web pages, and, more particularly, to a system and method that collects human experience analytics and web analytics data relating to preferences attributed to the actions performed by a web browsing visitor and modifies, in real-time, the web page layout of a web site based on the preferences of the visitor derived from the analytics data collected by the system to give the visitor a personalized web browsing experience.

### BACKGROUND OF THE INVENTION

A web page is a hypertext document on the World Wide Web (known as “WWW” or “W3”) that runs on the Internet of Things (“IoT”), or as commonly known today as the “internet.” The internet is the network of connected machines or computers that the web works on, as well as what other information and data is transmitted (i.e., emails, files, etc.). A website is one or more web pages linked together under a common domain name. A webpage is a file written in a particular language, HyperText Markup Language (“HTML”) that describes the page's content. An HTML page in today's modern WWE, includes style language that describes the overall look and presentation style of the web page. This style language is known as Cascading Style Sheets (CSS). CSS is designed to separate content and presentation, including layout, colors, and fonts. A web page also includes additional languages, such as JavaScript (“JS”)—programming language on the client side for webpage behavior that includes libraries—or WebAssembly programs, that are executed by the web browser to add dynamic behavior to the web page.

Dynamic web page provides a server-side and a client-side. The server-side is a web page, and its construction is controlled by an application server processing executable commands (e.g., scripts and parameters), that determine how the assembly of every web page will occur. A server-side is used to generate web content, manage user sessions, and control workflows. Languages used to create server-side web pages include but are not limited to ASP. ColdFusion, JS, Python, and more. Server-side languages are used to embed tags or markers within the source file of the web page on the web server. Accordingly, when a user on a computing device requests the server action on the web page, the web server interprets the tags or markers to perform functions.

The client-side of a web page processes the web page using JS operating on a browser (e.g., Chrome®, Mozilla FireFox®, Internet Explorer®). JS interacts with the page via Document Object Model (“DOM”)—a method that allows programmatic access in triaged format—to query the web page's state. Dynamic web pages are often cached and static to avoid wastefully straining the server or slowing down page loading if it had to generate the page on the fly. To enable the creation of interactive and animated documents, however, dynamic HTML or DHTML was released to allow scripting languages to change variables in a web page's language, affecting the look and function of otherwise static HTML page content fully loaded and during its viewing process. Thus, the dynamic characteristic of DHTML is localized on how a page is viewed, not in its ability to generate a unique page with each page load. The evolution of DHTML resulted in Asynchronous JavaScript and Extensible Markup Language (“XML”), collectively known as “Ajax.” With Ajax, web applications can send and retrieve data from a web server asynchronously without interfering with the display and behavior of the existing page. In other words, portions of a web page can be updated without having to reload the web page.

The collection of server and client-side components have revolutionized how users view and interact with web pages. Web pages, however, despite becoming more dynamic remain predominately static when it comes to user personalization. Particularly, web pages and their content (i.e., color scheme, text, and graphics) are not personalized to the user based on their content preferences, political affiliations, sexual preferences, age, hobbies, internet usage statistics, or entertainment viewing habits to name a few, to give the user a more enriched, personalized web page viewing experience.

Accordingly, there is an established need for a system and method that collects a user's human preferential experience analytics, social media analytics, or web analytics data and is capable of learning from the user's data to provide a user with personalized web page experience by modifying, in real-time, a web page layout of a web site running the system to include user layout, text, or otherwise graphical preferences derived from the analytics data collected by the system.

### SUMMARY OF THE INVENTION

The present invention is directed to a system and method that collects human experience analytics and web analytics data relating to preferences attributed to the actions performed by a web browsing visitor. The system is configured to modify the original layout of a web page in real-time into a personalized web page layout based on the preferences of the user derived from the analytics data collected by the system to give the user a personalized web browsing experience.

Introducing a first embodiment of the invention, the present invention consists of a method for providing a personalized web browsing experience, comprising the steps of:
accessing with an electronic device at least one web page hosted on a first server, the one web page displaying a web page layout comprising language that includes one or more editable sections;
providing a second server having access to the first server and configured to register user interactions on the web page by a user on the electronic device;
storing the user interactions as user data in a database on a client-side of the first server;
analyzing automatically the user data by an analytics application on the second server to generate targeted language that is incorporated to the editable sections of the web page; and
loading the targeted language when the user accesses the web page to provide a second web page layout.

In another aspect, modifying the web page layout to at least a second web page layout may occur in one exemplary embodiment while the web page is loading on the electronic device.

In another aspect, the second server includes a tracking machine that registers the interactions of the user on the web pages. The interactions include but are not limited to a user/visitor's ID, the session ID, the start time of a session, the duration of a session, or conversion actions. The interactions stored as user data are analyzed by the analytic machine to generate targeted scripts that incentivize the user to remain on the web pages and increase the percentages of interaction the user has with the web pages displayed to the visitor in its secondary format. In one exemplary form, the analytics machine of the second server utilizes a neural network model to learn about the user data to generate the targeted scripts.

In another aspect, the modifiable portions of the one or more web pages may include pixels or HTML tags incorporated into the script language of the one or more web pages. The pixels or HTML tags, in one exemplary embodiment, allow for the second server to make modifications to the text (e.g., HTML) and graphical visuals (e.g., CSS) of the web pages.

In another aspect, interactions of the user are transmitted to the database as user data continuously in time-intervals. In one exemplary embodiment, the maximum time interval is every 5 seconds.

In another aspect, the second server may execute a determination step before modifying the script language of the one or more web pages to change the web page layout to the second web page layout. The determination step includes whether the modifiable portions of the web page layout can be modified to a secondary web page layout within a time threshold. If a determination is no, the modifiable portions of the original web page layout of the one or more web pages remain unmodified. Alternatively, if a determination is yes, the modifiable portions of the original web page layout are modified based on the one or more targeted scripts to provide a secondary web page layout. In one exemplary embodiment, the time threshold is no more than 500 ms.

In another aspect, the second server may execute a determination step before modifying the script language of the language of the one or more web pages to change the web page layout to the secondary web page layout. The determination step includes whether enough the analytic machine has enough of the user data to generate the one or more targeted scripts changes to replace the modifiable portions of the script language of the web pages. If a determination is no, the modifiable portions of the original web page layout of the one or more web pages remain unmodified. Alternatively, if a determination is yes, the modifiable portions of the original web page layout are modified based on the one or more targeted scripts to provide a secondary web page layout.

In another aspect, the visitor data collected by the second server may be shared with at least one third-party aggregator to enrich the user data and generate enriched user data. The enriched visitor data is storable in the database and accessible by the analytics machine to generate the one or more targeted scripts used to modify the modifiable portions of the web pages.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a schematic block diagram of a web-based server system that provides a personalized web browsing experience in accordance with an exemplary embodiment of the present invention;

FIG. 2 presents a block diagram of the web-based server system in accordance with the present invention;

FIG. 3 presents an exemplary flow diagram of the web-based server system operating to modify a web page to provide a personalized web browsing experience in accordance with the present invention;

FIG. 4 presents a flow diagram of a timing system of the web-based server system querying whether a modification to a website can be done within a specified time threshold in accordance with the present invention;

FIG. 5 presents a schematic diagram of an exemplary embodiment of personalized web page layouts for visitors in comparison to an original web page layout in accordance with the present invention;

FIG. 6 presents a schematic diagram of an exemplary embodiment of two personalized web pages derived from the same URL in accordance with the present invention;

FIG. 7 presents a schematic diagram of an exemplary embodiment of HTML and text in personalized web page in accordance with the present invention; and

FIG. 8 presents a schematic diagram of an exemplary embodiment of the database of the present invention saving data on each particular website visitor and the data being available to other systems of the web-based server system in accordance with the present invention.

Like reference numerals refer to like parts throughout the several views of the drawings.

### DETAILED DESCRIPTION

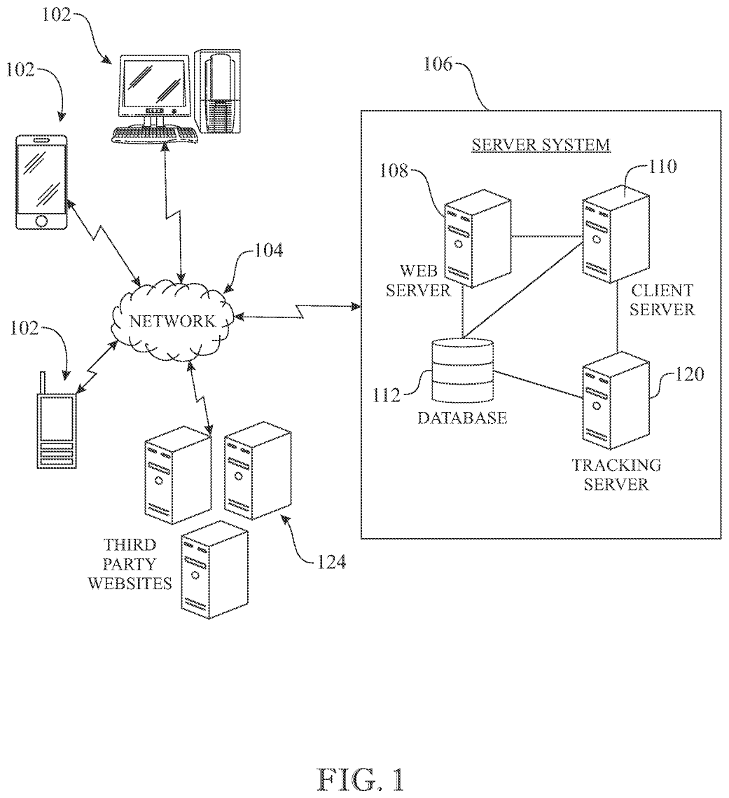

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The phrase “and/or,” as used herein, should be understood to mean “either or both” of the elements so joined, i.e., elements that are conjunctively presented in some cases and disjunctively presented in other cases.

As used herein, an element or step recited in the singular and proceeded with the word “a” or “an” should be understood as not excluding plural elements or steps, unless such exclusion is explicitly recited.

As used herein, the term “visitor” accessing a web page and “user” accessing a web site are used interchangeably.

As used herein, the term “webpage,” “web page,” or “web site” should be understood to mean a document or documents for the world wide web (WWW) that is identified by a unique uniform resource locator (URL) and can be accessed and displayed on an electronic device through a web browser. The data found in the web page may include HTML or XHTML format (or any other format) and include style sheets, scripts, or images for presentation. A webpage is displayable online with the aid of a web browser, such as but not limited to INTERNET EXPLORER, MOZILLA FIREFOX, or GOOGLE CHROME connected to the web server.

An electronic device 102, as used herein, refers to a device with a processor, memory, network interface, and a storage device. Electronic devices 102 are capable of executing instructions. The term electronic device includes, but is not limited to, a personal computer, server computers, computing tablets, set-top boxes, video game systems, personal video recorders, telephones, cellular telephones, digital telephones, personal digital assistants (PDAs), portable computers, notebook computers, and laptop computers. Electronic devices may run an operating system, including, for example, variations of the Linux, Unix, MS-DOS, Microsoft Windows, Palm OS, Symbian OS, and Apple Mac OS X operating systems. Electronic devices also include communications software that allows for communication over network. Depending on the electronic device 102, the communications software may provide support for communications using one or more of the following communications protocols or standards: the User Datagram Protocol (UDP), the Transmission Control Protocol (TCP), the Internet Protocol (IP), and the Hypertext Transport Protocol (HTTP); one or more lower-level communications standards or protocols such as, for example, the 10 and/or 40 Gigabit Ethernet standards, the Fiber Channel standards, one or more varieties of the IEEE 802 Ethernet standards, Asynchronous Transfer Mode (ATM), X.25. Integrated Services Digital Network (ISDN), token ring, frame relay, Point to Point Protocol (PPP), Fiber Distributed Data Interface (FDDI); and other protocols. Electronic devices may include a network interface card, network chip, or network chipset that allows for communication over network 104.

The techniques of executable commands and execution of algorithms described herein may be implemented in software stored on storage media accessible either directly or via a storage device such as a hard disk drive or other drive included with or otherwise coupled or attached to an electronic device. As such, storage media are readable by an electronic device or other machine and may be referred to as machine readable media. These storage media include, for example, magnetic media such as hard disks, floppy disks, and tape; optical media such as compact disks (CD-ROM and CD-RW) and digital versatile disks (DVD and DVD+RW); flash memory cards; and other storage media. A storage device is a device that allows for reading and/or writing to a storage medium. Storage devices include but are not limited to hard disk drives, DVD drives, flash memory drives (such as readers and writers), and others.

The processes, methods, functionality, and features of analytics tracking server 120 described herein may be embodied in whole or in part in software that operates on a tracking server, another server and/or on an electronic device. The software may be in the form of, for example, one or more of an applet (e.g., a Java applet), a browser plug-in, an application program plug-in, a component object model (COM) object, a dynamic linked library (DLL), a script (e.g., JavaScript, VBScript), ActionScript, an ActiveX control, a link, iFrame tag, client-side extensions (CSSE), add-ons, or other extensions as TOOLBAR that alters the JavaScript on a user's client-side server website, a subroutine, an operating system component or service, firmware, an application program, and/or a combination thereof. The software may be implemented in one or more programming languages such as, for example, high-level programming languages including C. C++, Java, Visual Basic, the hypertext markup language (HTML), Perl, Python, and others, or low-level assembly and machine language. The site sever as well as the tracking server, in one exemplary embodiment, can be pinged by a DNS record, such as a CNAME record or ANAME record, that is readily available. The software is downloadable and otherwise executable by third-party websites 124 that grant access to the system 106 to modify, alter, or otherwise change portions of the third-party webpage.

Electronic devices 102 communicating with one another, in some exemplary embodiments, are interconnected to the Internet through many interfaces including a network 104, such as local area network (LAN) or a wide area network (WAN), dial-in-communications, cable modems and special high-speed ISDN lines. An electronic device 102 could be any device capable of interconnecting to the internet, including a web-based phone, personal digital assistant (PDA), or other web-based connectable equipment. A network 104 may include wireless communication including but not limited to: WLAN (wireless local area network, Wi-Fi, (IEEE 802.011), WPANS (wireless personal area networks, such as Bluetooth (IEEE 802.15), Infrared, ZigBee, WMAN (wireless metropolitan area network, such as WiMax (IEEE 802.16)), WWAN (wireless wide area networks, internet), and GAN (global area network), a mobile wireless communication system, such as 3G, 4G, or 5G, and an internet protocol based communication system. The network 104 may also include a wired communication including but not limited to, fiber optic systems, a telephone network such as a PSTN (public standard telephone network). The network 104 may further include a radio frequency network (RF), a cable network, a satellite network, and an internet or intranet network, where each network is adapted for transmitting, and receiving data, information, audio, video, texts, messages, emails, and files from the electronic device 102, and server system 106. It will be noted that network, interface, communication and information exchange equipment, components or peripherals may be employed, including, but not limited to, use of base stations, servers, routers, switches, repeaters, towers, antennas, Ethernet hubs, wired or wireless data pathways, modems, virtual private networks (VPN), modems, proxy servers, application program interfaces (APIs), networking adapters, or gateways. Encryption protocols may also be employed to secure the transmitted information, data, or messages. For example, a few exemplary forms of encryption include IPsec, or secure sockets layer (SSL), and symmetric or asymmetric encryption.

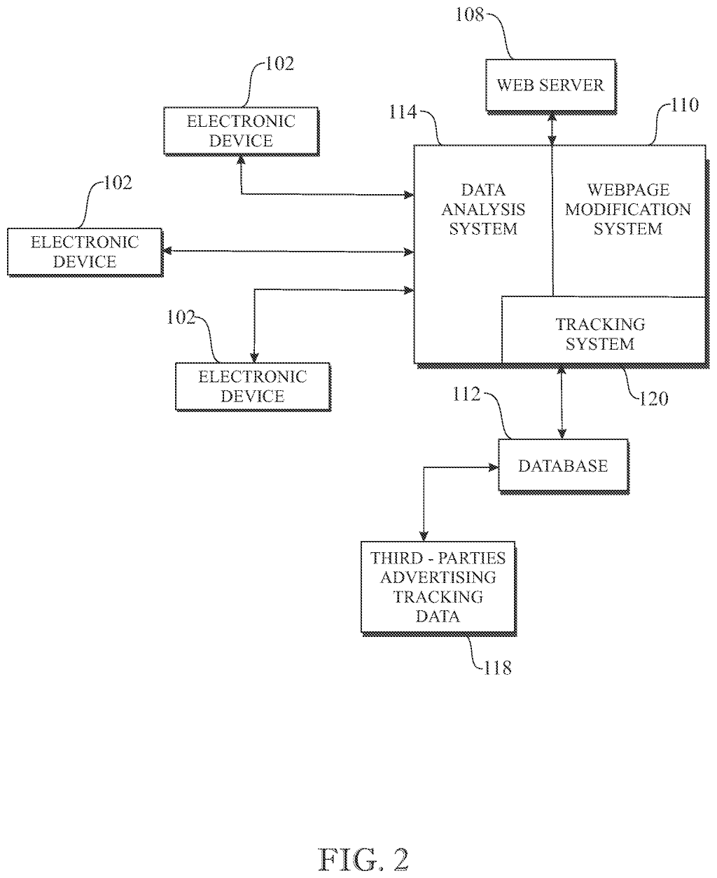

Referring initially to FIGS. 1 and 2, there is shown a schematic view of a web-based server system 106 (hereinafter “server system”) in electronic communication with one or more electronic devices 102 over a network 104. The server system 106 includes a web server 108, a client-server 110, a database 112, and a tracking server 120. The database 112 contains informational data on each user (“user data”), as discussed further herein below. In one exemplary embodiment, to provide a personalized web experience in accordance with the present invention, a web host must grant access to the server system 106 to run one or more executable commands.

After access is granted, the tracking server 120 of server system 106 is configured to collect information on users accessing/visiting enabled web pages on the world wide web via a client-side JavaScript library. The tracking server 120 of the instant invention tracks a visitor's ID, the session ID, the start time of a session, the duration of a session, page-specific duration, the time spent on an activity while visiting the website, screen dimensions of the electronic device visitor is using to access the web site, utm parameters at the start of a session to identify the traffic source amongst other valuable information (e.g., running ad campaigns), and phone numbers appended to the web site utilized for tracking purposes (i.e., call tracking). The tracking server 120 also collects metadata, which includes but is not limited to the visitor's age, gender, race, religion, education level, income, net worth, political affiliation, credit information (i.e., scores, card brands, outstanding debts), prior buying habits, vehicle data, street address, mailing address, mortgage information, parental status, relationship status, home value, home details (i.e., bedroom count, bathroom count, floors, square footage, year built, etc.), occupation, diagnosed conditions, number of children, child ages, pets, hobbies (including sports), allergies, internet usage statistics, glasses use, medication usage, including OTC supplements, and TV usage (e.g., favorite shows and viewing habits). In one exemplary embodiment, maintaining a client-side JavaScript library may expose open endpoints where information on the visitor's session is intermittently shared. These open endpoints may allow for spam trafficking to occur where tens of thousands of requests per second are made, which could affect the informational database for the visitor and slow the system to a crawl. Accordingly, as a security method, the technique of rate limiting, including but not limited to domain or originating IP address limiting, is used to control the amount of incoming or outgoing informational traffic within the system's network.

The tracking server 120 is also configured to track the user's input commands on the electronic device 102 used while navigating the website. For instance, the mouse movements on the X and Y coordinate axis are tracked, as well as mouse click events, navigation events (i.e., going from one web page to another), form submission events that include but is not limited to sensitive information captured that can be hashed, including form name, time, keystrokes from a physical keyboard or electronic keyboard, and other identifying information about the user, and on-page conversion actions that occur. A conversion action, as discussed herein, comprises a lead form submission, the user viewing a product, placing the product in a cart, or purchasing an item offered on the web page, an inbound call generated by the web page, or any other alternative action as deemed by the host of the web page as a conversion. The tracking server 120 of the instant invention is configured to identify actions for tracking purposes in at least two methods. The first method includes the tracking server 120 tracking a client-side pixel (i.e., measurement and reporting of events to external servers), with an alternative method of a postback URL. In a postback URL, a URL is created when the tracking server 120 identifies a conversion action. The URL is then accessible to third parties when the conversion takes place. The third-party sources the conversion action and contextualizes the action (e.g., assigns a conversion value, assigns a product name or conversion type). Either method, however, attributes the conversion action to the session ID and/or contributes the conversion to a category and name. For instance, the conversion was a purchase, a lead, a call, or inquiry, etc. It should be readily understood that a session ID is a unique number that a website server assigns a specific user for the duration of the user's session on that website.

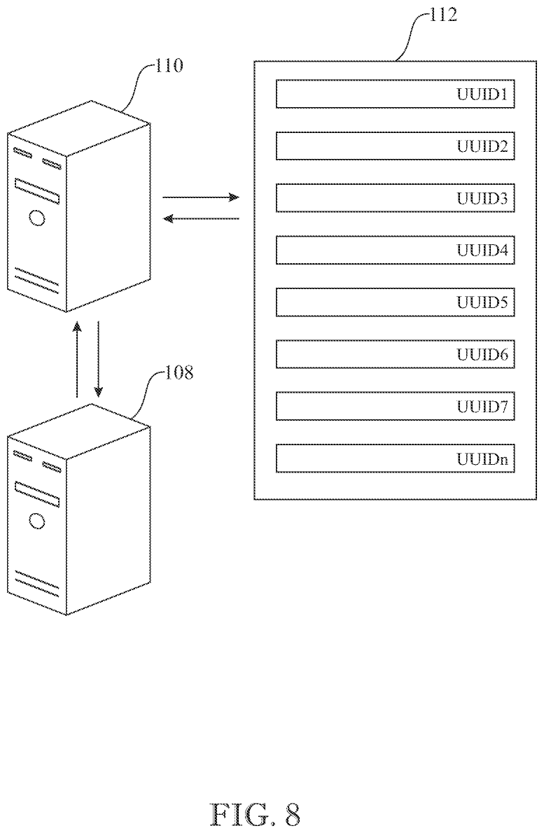

Referring now to FIGS. 1, 2, and 8, all the collected data by tracking server 120 is sent to database 112 of server system 106. The data sent to server 112 is initially stored with a session ID on web server 108 before being consolidated, stored, and labeled. The consolidated data is stored to include a unique customer ID (“UUID”). Each independent visitor to the website will have its own UUID with unique data information about that particular user (e.g., UUID1, UUID2, UUID3 . . . UUIDn) (See FIG. 8). The data, as discussed above, is utilized to learn about the visitor's individual likes, dislikes, shopping tendencies, browsing tendencies, viewing tendencies, spending history, marital status, etc., to provide a unique browsing experience. The UUID of each visitor is stored on the client-server 110 to reduce latency between when a visitor enters the website and when the server system 106 modifies the website. In one exemplary embodiment, the server system 106 collects and transmits data information to the web server 108 in maximum intervals of 5 seconds. However, it should be readily understood that the data collected flows instantly to the web server 108 so that data is not lost if the visitor closes the session before the maximum time interval. Put differently, data collection begins immediately when the visitor starts a session even though the system does not have enough time to modify the website. The data flow is continuously consolidated, stored, and otherwise categorized to the corresponding UUID of the visitor and stored in the database 112 in communication with the client-server 110 to maintain latency at an absolute minimum. This continuous data collection allows the data analysis system 114 of the instant server system 106 to learn about the visitor. For example, a visitor is browsing a few web pages that have enabled access to the server systems 106. As the user visits each web page, the tracking server 120 of the instant system tracks the user's movements and actions (as outlined above). The information that is consolidated and saved under the visitor's UUID is then reviewed by the data analysis system 114. The data analysis system 114 includes one or more executable commands to learn about the tendencies, preferences, patterns, likes, dislikes, and other information about the visitor to provide recommendations to the modification system 116 to implement changes to the web page for the next time the visitor visits the site, but more on that later.

In one exemplary embodiment, the data analysis system/machine 114 uses a supervised learning algorithm to produce information that can be utilized by the server system 106 to provide a personalized web experience. Under a supervised learning algorithm, the data analysis system 114 takes classified data (i.e., classification results using binary) or regressed data (i.e., real numbers, either decimal or round, which are assigned to data to estimate results) and uses the data to learn and grow. Understood supervised learning algorithms include but are not limited to decision tree structures learning, support vector machine learning, naïve bayes learning, linear regression learning, and logistic regression learning. In another exemplary embodiment, the data analysis system 114 may use unsupervised learning algorithms to provide valuable information that can be used by the server system 106 to provide a customizable web experience. In an unsupervised algorithm approach, raw data is given to the system to create models and evaluate the relationships between the data provided. Unsupervised algorithms include clustering (i.e., sorting unlabeled data points into pre-defined clusters), K-means clustering (i.e., taking in the pre-determined clusters and plotting out all the data regardless of the cluster. The system then plots a randomly selected piece of data as the centroid for each cluster. From there, it sorts the remaining data points into clusters based on their proximity to each other and the centroid data point for each cluster), or gaussian mixture model (i.e., sorting data into pre-determined clusters based on proximity).

Alternatively, the data analysis system 114 may run a neural network algorithm that varies the weights of variables and their bias to recognize patterns without being explicitly programmed. For instance, in one exemplary embodiment, a deep neural network forecasts visitor preferences through repetitive action from the multiplicity of data collected from the visitor(s) by the tracking server 120. The data is processed through successive layers until it can accurately forecast outcomes for individual visitors and store that information in the UUID corresponding to the visitor. For instance, the analysis system 114 may show that an action has resulted in a percentage increase in conversion rate for a particular subset of visitors visiting a webpage, whereas the same call to action has resulted in a decreased percentage rate of conversion for other visitors. Based on that information, the analysis system 114 shifts its protocols for those particular visitors to a different call of action that is more favorable to increase the conversion rates. The shifting of protocol occurs individually for each visitor to increase the conversion rate, and that information used to increase the conversion rate is stored in the visitor's UUID.

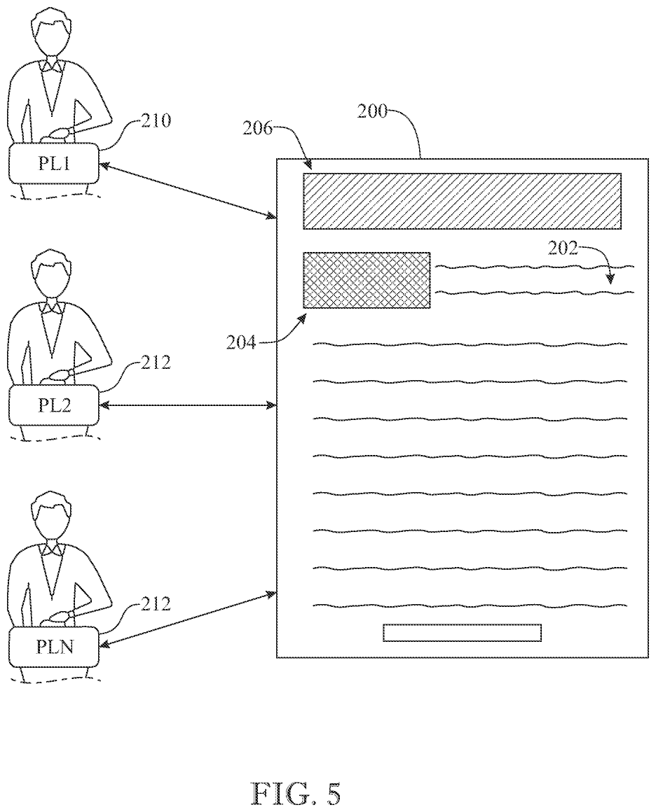

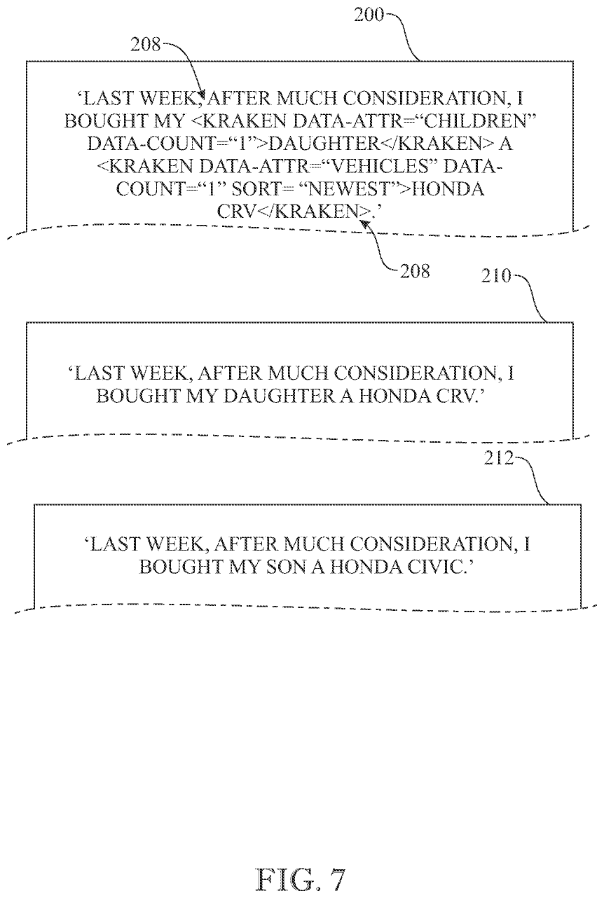

Referring now to FIGS. 1, 2, and 5 through 8, an explanation of how modifications to a web page are done by the server system 106 is generally shown and described. The server system 106 is capable of modifying a web page or portions of a web page for each individual visitor depending on the information learned about the visitor and stored in the UUID and the permissions given by the web page host on what items on the web page can be modified. As mentioned above, the data analysis system 114 is configured and capable of machine learning to learn about the visitor's preferences. The information learned about the visitor is passed on to the modification system/machine 116 on the client server 110 of the server system 106. How changes are made to a web page may occur in at least two ways. In a first exemplary embodiment, the hosting web page may grant the server system 106 access to the document object manager (DOM) of the website to make changes in the form of raw HTML or CSS. In this particular embodiment, the script library provided by the server system 106 that includes a number of executable commands is exposed to the DOM of the web site, which the DOM proceeds to execute. For example, as seen in FIGS. 5 through 7, an original web page 200 is exemplarily shown to include text 202, generated content 204, and images 206 in a particular format. The modification system 116 of the present invention scans the DOM of the original webpage 200 for specific HTML tags that grant access to the server system 106 to make changes (FIG. 7). The script (unseen to the actual visitor) may include the following, “Last week, after much consideration, I bought my <KRAKEN data-attr=“children” data-count=“1”>daughter</KRAKEN> a <KRAKEN data-attr=“vehicles” data-count=“1” sort=“newest”>Honda CRV </KRAKEN>.” In this example, the term “KRAKEN” is the specific HTML Tag or key the server system 106 requires to modify the web page. In a first personalized web layout 210, the visitor may view the text in the webpage in real time as, “Last week, after much consideration, I bought my daughter a Honda CRV.” The server system 106 may have opted to specify the child's gender and specific vehicle model because the data shows that the visitor has a daughter and statistical data shows that the visitor or daughter may prefer a Honda CRV over any other vehicle. A second visitor, however, in a second personalized web layout 212, may view the text in the webpage in real time as, “Last week, after much consideration, I bought my son a Honda Civic.” This difference in the text found in the web page may be because the visitor has a son instead of a daughter, and a Civic is more in tune with what his son would prefer based on the harvested data stored in the visitor's UUID.

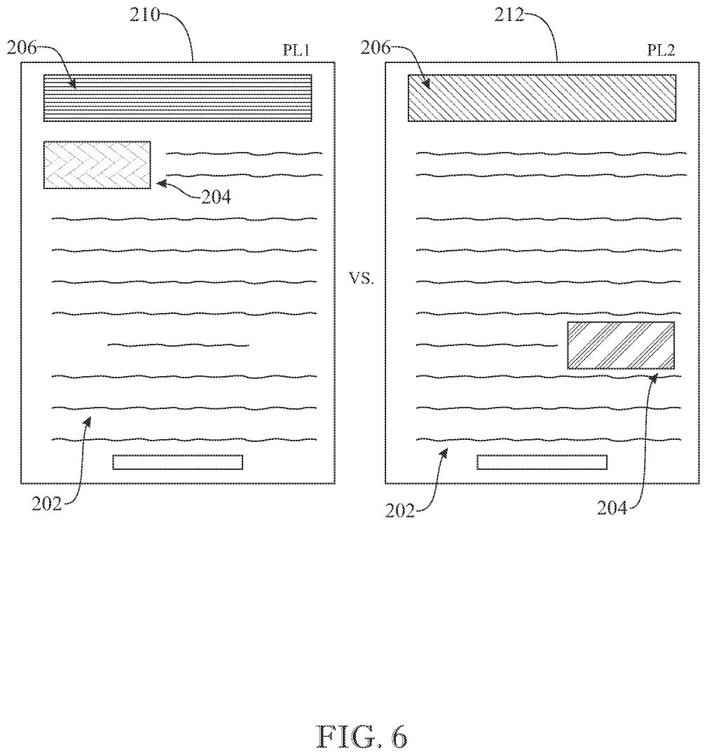

Accordingly, the HTML tags effectively represent areas of the webpage that the server system 106 has access to modify to provide a targeted/personalized web experience. In this particular example, the script includes HTML tags 208, where the modification system 116 can make changes to the script based on the recommendations made by the analytics system 114 after learning more about the visitor and the stored data in the visitor's UUID in database 112. Accordingly, each visitor to the web site may have their own personalized web page layout. For instance, as seen in FIG. 5, a first visitor may have a personalized web page 210 that differs from a second and third personalized web page 212, 214 of respective visitors. Consequently, personalized layout 210 for a visitor may have different text (FIG. 7) and a different color scheme, image(s) 206, or generated content 204, and arranged differently than the personalized layout 212 for a second visitor (FIG. 6). In this regard, the system 106 may include resource-specific permission instructions. The resource-specific instructions limit or otherwise direct what changes system 106 can make and to what web pages. Accordingly, the set instructions to personalize a layout for a visitor do not affect another. For example, a determined list of changes for a first user can only occur with the client-server associated with that user. Other client servers cannot communicate with the script intended for that particular visitor (i.e., access to other servers is blocked). These permission sets are stored externally from both resources affected to limit the possibility of compromise. Moreover, databases may only be queried from specific resources with granted access by the system and through specific ports. All other requests from other locations that are not recognizable are blocked, well before any script can execute the changes to a webpage. This prevents the web page layout from being hijacked with changes that were not promulgated by the system itself.

One other security feature provided by system 106 is limiting client-side tag usage to protect the visitor's personal identifiable information (PII). For example, with the intent of keeping PII secure and out of the reach of unwanted parties, the system 106 prevents a visitor's name, phone number, or email address from being visible or accessible from the client side. In other words, PII information is masked or illegible to any party that does not have access to the system (i.e., encrypted). In one exemplary form, by adding language such as but not limited to, <KRAKEN data-attr=“email”> (or “first-name”, “last-name” etc), information relating to the visitor's PII would be secured from unwanted access. Other PII, however, not specifically identified by the system as non-attainable PII, would be visible and accessible on the client-side.

To give a little more context to the above, the following example is provided. In an exemplary scenario where several third-party web pages have given the server system 106 of the present invention access to its server, the tracking server 120 begins to collect data on the visitor, as detailed above. The data collected on the visitor is then stored in the UUID of that particular visitor in database 112. The visitor in this example is a male, in his late 50s, a sports enthusiast, and has a preference for a political party. Having recognized these few data points on the visitor, the server system 106, in communication with the third-party web page, modifies the web page in real-time when the visitor visits a web page that grants the server system 106 access. The changes to the website may include color schemes that match his preferred political party (e.g., blue or red), includes advertisements for sporting events of his preference (e.g., Formula 1 racing, NBA, MLB, NFL, etc.), changes in multi-media images or videos, changes in links to other third party sites, changes to pop-up ads, or includes other forms of information or offers that a man like him would find enticing to increase the chances that the visitor performs a conversion action or remains on the web page longer. All of the data stored in the UUID on the client side of the browser-side cookie is used to modify the webpage to provide a personalized experience. In the event, that server system 106, namely, the analysis system 114 identifies that the UUID is non-existent (i.e., there is no data on the visitor yet), the web page visited by the visitor remains unchanged. In alternative embodiment, however, the system's analysis system 114 may utilize data from a plurality of other visitors that in the aggregate match the characteristics of the visitor and make modifications to the web site based on those findings. Accordingly, it should be understood that a change to a web page may occur if the server system has available data in the UUID that can be analyzed to provide a personalized web page or no available data in the UUID for that particular visitor but available data on a plurality of other visitors that share common characteristics. The characteristics may include, as outlined herein, age, political preferences, sporting preferences, advertising preferences, geographical locations, etc.

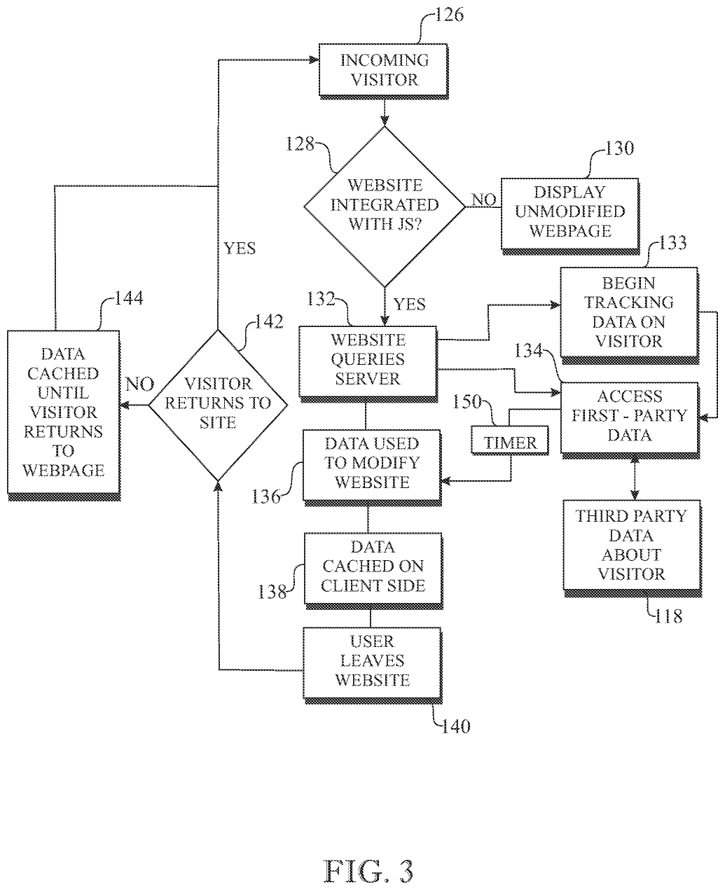

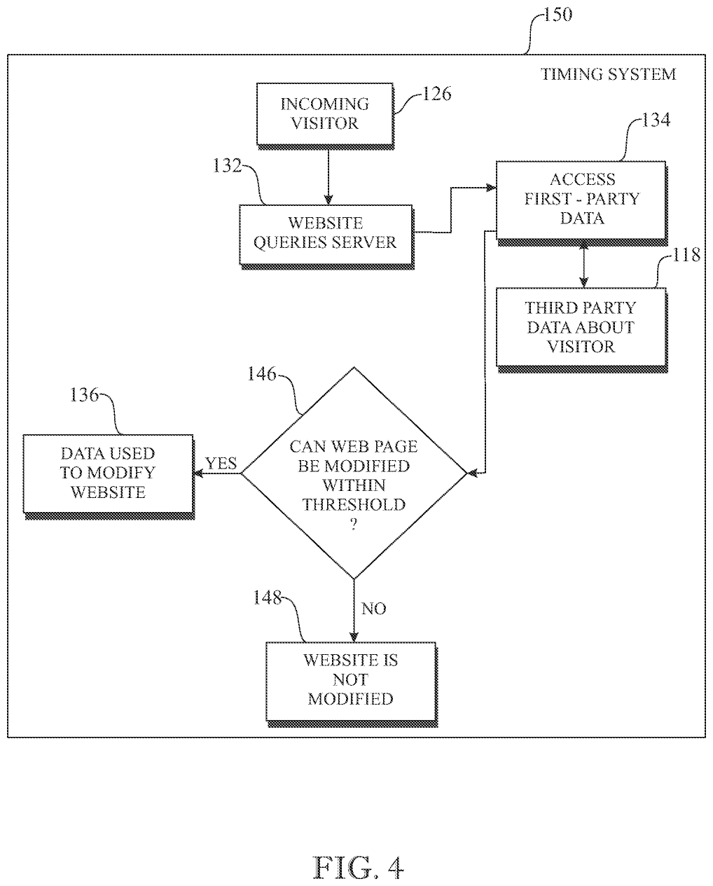

Turning now to FIGS. 1 through 4, particularly FIGS. 2 and 3, a diagram illustrates a flow chart on the general process of how the server system 106 modifies a third-party website 124. In a first step 126, a visitor accesses the world wide web and goes to a third-party webpage. When launching the third-party webpage, a first determination step 128, occurs to determine whether the server system 106 has access to the third-party website. If the determination is “no,” then the website loads unmodified 130. In other words, with the original content, the web host provides its visitors. Alternatively, if the determination is “yes,” then the web server 108 is pinged or queried 132 to determine if the website has any HTML tags or any tags that grant access to the server system 106 to modify content. Simultaneously, tracking server 120 of server system 106 automatically begins to track the visitor's actions and conversions and transmits the data to be stored in the visitor's UUID. After identifying the HTML tags on the website, the server system 106 accesses the analyzed information on the UUID about the visitor and makes it available for the modification system 116 of the server system 106 to make website modifications 136. If the data in the UUID of the visitor is insufficient to make website modifications, the website remains unmodified when it loads for the visitor or changes based on the data gathered from a plurality of visitors that share common characteristics with the visitor. The modifications to the website may include but are not limited to the examples provided herein above.

The modification to a website is not only limited to whether the UUID has sufficient data on the visitor to make changes. Another limiting factor to whether a website is modified includes how long the modification will take place to reduce unwanted latency. To do that, server system 106 includes a timing system 150 that is programmed to interrupt the modification sequence of the timing sequence if the modification to the website takes longer than a specified threshold. For instance, as seen in FIG. 5, the website pings or queries 132 the site to determine if the website has any HTML tags or any tags that grant access to the server system 106 to modify content. If the UUID of the visitor has sufficient data on the visitor to modify the website, the timing system automatically makes a determination step if the modifications to the web page can be completed within the specified threshold. If the system response is “no,” then the website is not modified by the system and remains unchanged from its original content. On the contrary, if the system response is “yes,” then the webpage is modified in accordance with some of the examples provided above. In one exemplary embodiment, the system threshold to modify the website is within 500 ms.

Returning to FIG. 3, all of the data for the visitor is cached 138 on the UUID on the client-side server of the visitor. As iterated above, this is done to reduce latency when server system 106 is executing its commands to modify the website to provide a personalized web experience. The purpose of modifying the website for each visitor is to prolong the time the visitor spends on the website, which could increase the probability of the visitor converting to a desired action (e.g., purchase an item, call a number, fill a form, etc.). After the visitor leaves the website 140, the system is on standby, determining 142 whether the visitor is returning to the website. If the visitor has not returned, the data is cached 144 for future reference. In one exemplary embodiment, the data is in a pre-ready state for 30 seconds waiting to confirm whether the visitor returns. If the visitor does not return to the website within the 30 seconds, the system reallocates resources to optimize performance and caches the data for future reference.

The server system 106 is also capable of tracking the changes it makes to a web page layout for each visitor and analyze the changes to improve reliability and increase conversion rates and does this through a grid and element identification system. For instance, when a web page loads or generated on the server-side that is being provided to the visitor, every element within the DOM is assigned a custom value. The value assigned specifies the type of element (e.g., document metadata, content sectioning, text content, inline text semantics, images, multimedia, embedded content, forms, interactive elements, and other web components to name a few) as well as the position of the element in relation to other elements on the web page. For example, an image (<img>) contained within the second section (<section>) located within the body (<body>) element could receive a custom ID of 1-2-1 (assuming the image is the first element located within the second section of the DOM). Alternatively, if the images is the second element within the section, the custom ID would then be 1-2-2. The first number represents the portion of the webpage (e.g., 0=Header, 1=Body, 2=Footer), and the second number represents the top-level element belonging to the final element in question. Take for example the following exemplary HTML code:

```
    <html lang=″en″>
    <head “kID” = “0”>
      <meta charset=″UTF-8″ “kID” = “0-1”>
  <meta name=″viewport″ content=″width=device-width, initial-scale=1.0″ “kID” = “0-2”>
      <meta http-equiv=″X-UA-Compatible″ content=″ie-edge″ “kID” = “0-3”>
      <title “kID” = “0-4”>HTML 5 Boilerplate</title>
      <link rel=″stylesheet″ href=″style.css″ “kID” = “0-5”>
    </head>
    <body “kID” = “1”>
    <script src=″index.js″ “kID” = “1-1”></script>
    <section “kID” = “1-2”>
    <h1 “kID” = “1-2-1”>This is a headline</h1>
    </section>
    </body>
</html>
```

As a result, when the web page layout generation or modification is complete, the server system 106 automatically stores the custom values that were assigned to key value pairs as well as the CSS class name, manual styles applied, and any text that may be contained within an element (e.g., text within a button). The foregoing is done after the visitor leaves the website so that the system 106 can accurately reconstruct and analyze the website including the web page layout(s) that included all of the applicable modifications.

Although in the above exemplary description, server system 106 has exclusively relied on informational data gathered about a visitor via its tracking server 120, server system 106, in one exemplary form, is further designed and configured to work with third parties 118 to optimize or otherwise enrich the data information on visitors. Generally, enrichment occurs after a visitor has left the website, and the data collected during the visitor's visit is provided to a third party. For example, after the server system 106 captures information, such as personally identifiable information such as an email, a phone number, or an address, about the visitor, the information may be provided to a third-party aggregator. Third-party aggregators include but are not limited to Neustar, Data-Axle, Factual, Acxiom, InfoGroup, and Localese, to name a few. These exemplary third-party aggregators are utilized to learn more about the visitor to provide more intuitive and personalized web page experiences in the form of additional visitor data. The visitor data provided by the third-party aggregators is subsequently storable in the visitor's UUID.

The server system of the present invention is also capable of providing information on visitors to third parties to improve their advertising campaigns. For instance, after a conversion event occurs, the server system updates the UUID on the visitor and provides it to a third-party aggregator to enrich the data. Relevant data information is shared with other third parties via an asset workflow platform designed to automatically prepare and connect creative content with any media, such as AdBridge™. Sharing this type of data, in one exemplary form, allows other third parties, such as FACEBOOK®, INSTAGRAM®, or TWITTER®, to name a few, that a particular visitor within an identifiable email, phone number, physical address, converted at a particular time on a particular website. The third party website can then utilize the information on the visitor to run a more effective personal marketing plan to target that particular visitor.

To ensure that the server system is working at optimum level and its routines are providing the best results when it comes to providing a personalized web experience, the server system 106 includes an accessible overview platform on the web server 108. To gain access to the platform, a user must be authenticated by an authentication system that may include software-based, and/or hardware-based devices. Authentication may comprise a single-tier, two-tier, or multi-tier authentication protocol process. Examples of authentication protocols may include, but is not limited to, smart card technology, browser or digital certificates, hardware OTP tokens, software tokens, hardware security modules (HSM), or biometric authentication using one or more sensors for sensing fingerprints, hand geometry, iris or retinal patterns, or voice sampling or recognition. Other authentication protocols may include, IP security (IPSec) authentication methods, including the Kerberos protocol, private or public key certificates, or a simple pre-shared secret key, Challenge Handshake Authentication Protocol (CHAP), or the Extensible Authentication Protocol (EAP). Authentication based on single or multiple tier authentication system may include for example, use of a name/password, setting up answers to challenge questions, setting-up image recognition, or providing numerical or alphabetical information in a captcha text-entry box. The overview of the platform is designed and configured to query third party providers that run ad campaigns, such as FACEBOOK®, INSTAGRAM®, and the like, to extract their performance metrics based on the captured data on each visitor the server system 106 has obtained. Performance metrics may include but are not limited to ad campaign impressions, clicks, and spending, to name a few. For example, when a user is authenticated and gains access to the server system's overview platform, the user is able to review how a third party campaign is doing based on the information it provided the third party. The platform may query the session table and request information on all the visitors that came from that third party ad campaign and who had a conversion from it. The server system takes that information and then queries the third party for its API performance metrics on that particular campaign and compares the data using some of the techniques described herein above to obtain a more accurate assessment of the conversion rates for a particular ad campaign.

The term processor, as used herein, refers to central processing units, microprocessors, microcontrollers, reduced instruction set circuits (RISC), application specific integrated circuits (ASIC), logic circuits, and any other circuit or processor capable of executing the functions described herein. As used herein, the terms “software” and “firmware” are interchangeable, and include any computer program stored in memory for execution by the processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer Software, firmware, hardware or any combination or subset thereof, wherein the technical effect is providing a self-building tracking mechanism for a web-providers web content. Any such resulting program, having computer-readable codemeans, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory Such as read-only memory (ROM), and/or any transmitting/receiving medium Such as the Internet or other communication network or link. The article of manufacture containing the computer code may be made and/or used by executing the code directly from one medium, by copying the code from one medium to another medium, or by transmitting the code over a network.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A method for providing a personalized web browsing experience, comprising the steps of:
accessing with an electronic device at least one web page hosted on a first server, the one web page displaying a web page layout comprising script language that includes one or more input sections;
providing a second server having access to the first server and configured to register user interactions by a user on the electronic device;
storing the user interactions as user data in a user database on a client-side of the first server;
analyzing automatically the user data by an analytics application on the second server to generate targeted scripts that is incorporated to the input sections of the web page; and
loading the targeted scripts when the user accesses the web page to provide a second web page layout.

2. The method of claim 1, wherein modifying the web page layout to the second web page layout during the loading occurs within 500 ms.

3. The method of claim 1, wherein the second server includes a tracking application that executes one or more commands to register the user interactions including keystrokes, mouse movements, or other actions taken by the user while navigating the web page.

4. The method of claim 1, wherein the analytics application generates the targeted scripts based on user preferences derived from an analysis of the user interactions.

5. The method of claim 1, wherein incorporating the targeted scripts into the input sections of the web page layout change web page content on the web page.

6. The method of claim 1, wherein the user interactions are stored in the user database continuously in time-intervals.

7. The method of claim 6, wherein the time-intervals include a maximum time interval of 5 seconds.

8. The method of claim 1, wherein the user data is distributable with at least one third party aggregator to enrich the user data and generate enriched user data.

9. The method of claim 8, wherein the enriched user data is analyzed by the analytics application to generate enriched targeted scripts that is used to modify the web page layout.

10. A method for providing a personalized web browsing experience, comprising the steps of:
providing a platform host stored in a computer-readable memory and executed by at least one processor on at least one server in electrical communication with at least one database, a network interface, a determination application, an analytics application, a timer, a tracking application, and a modification subsystem allowing the platform host to:
connecting over a network with a first server hosting a web page configured to display a web page layout;
communicating, via the modification subsystem, with the document object manager (DOM) of the first server to make changes to script language of the first web page layout and incorporate language therein to provide one or more input sections that when the web page loads are configured to selectively modify the web page layout;
tracking, via the tracking application, user interactions by the user;
storing the user interactions in the database; and
analyzing, via the analytics application operating on a second server of the platform host, the user interactions to generate one or more targeted scripts that are applied to the one or more input sections,
wherein loading the web page including the one or more targeted scripts modifies the web page layout of the web page to a second web page layout.

11. The method of claim 10, wherein the modification of the web page layout to the second web page layout occurs within 500 ms.

12. The method of claim 10, wherein the user interactions are stored in the user data continuously in time-intervals.

13. The method of claim 12, wherein the time-intervals include a maximum time interval of 5 seconds.

14. The method of claim 10, wherein the tracking application tracks the modifications made from the web page layout to at least the second we page layout.

15. A method for providing a personalized web browsing experience, comprising the steps of:
providing a platform host stored in a computer-readable memory and executed by at least one processor on at least one server in electrical communication with at least one database, a network interface, a determination application, an analytics application, a timer, a tracking application, and a modification subsystem allowing the platform host to:
connecting over a network with a first server hosting a web page configured to display a web page layout;
communicating, via the modification subsystem, with the document object manager (DOM) of the first server to make changes to script language of the first web page layout and incorporate language therein to provide one or more input sections that when the web page loads are configured to selectively modify the web page layout;
tracking, via the tracking application, user interactions by the user;
storing the user interactions in the database;
analyzing, via the analytics application operating on a second server of the platform host, the user interactions to generate one or more targeted scripts that are applied to the one or more input sections; and
executing a determination step to determine whether the modification subsystem is capable of modifying the web pay layout to include the one or more targeted scripts and provide the user with at least a second web page layout within a time threshold,
if yes, execute and load the one or more targeted scripts to modify the web page layout,
if no, do not load the one or more targeted scripts and leave the web page layout unmodified.

16. The method of claim 15, wherein the time threshold is approximately 500 ms.

17. The method of claim 15, further comprising the step of:
executing a determination step to determine whether the analytics application has analyzed a sufficient amount of the user interactions to generate one or more targeted scripts that the modification subsystem can implement to modify the web page layout,
if yes, execute and provide the modification subsystem with the one or more targeted scripts,
if no, do nothing and allow the web page layout of the web page to load unmodified.

18. The method of claim 15, wherein loading the one or more targeted scripts into the input sections of the web page layout change the content displayed on the web page.

19. The method of claim 15, wherein the tracking application executes one or more commands to register the user interactions including keystrokes, mouse movements, or other actions taken by the user while navigating the web page.

20. The method of claim 15, wherein the user data is distributable with at least one third party aggregator to enrich the user data and generate enriched user data, and the enriched user data is analyzed by the analytics application to generate enriched targeted scripts that is used to modify the web page layout.
